(19) United States
(12) Patent Application Publication
(10) Pub. No.: US 2006/0277077 A1
(43) Pub. Date: Dec. 7, 2006

(54) Method for writing an insurance policy entitled insured tenant leasing

(76) Inventor: James Lee Coleman JR., College Park, GA (US)

Correspondence Address: Mr. James L. Coleman Jr., 3110 Godby Road # 20E, College Park, GA, 30349, US

(21) Appl. No.: 11/285,793

(22) Filed: Nov. 22, 2005

Related U.S. Application Data
(60) Provisional application No. 60/630,088, filed on Nov. 22, 2004.

(51) Int. Cl. G06Q 40/00

(52) U.S. Cl. 705/4

(57) ABSTRACT

A method for writing an insurance policy and algorithm for providing a final premium amount to pay for the coverage contracted with an insurer. Discrete dollar amounts for pre-selected moving and pre-selected storage service expenses are comprised into a unit loss value amount. Data retrieved from census records and other sources comprising the number of rented (homogenous) units for a specified geographical area, and data from courthouse records comprising the number of evictions for the same specified geographical area, profit margin data and the unit loss value amount are transformed by entering the data into a spreadsheet or other data processing apparatus, comprising software used to manipulate the numerical data through a series of mathematical calculations in an algorithm, into the final premium amount utilized by the method for writing an insurance policy, enabling coverage in an insurance contract for tenant's exposure to property (possessions) losses during the eviction.

### CROSS-REFERENCE RELATED APPLICATION

(Not Applicable)

### FEDERALLY SPONSORED RESEARCH

(Not Applicable)

### SEQUENCE LISTING REFERENCE

(Not Applicable)

### BACKGROUND OF THE INVENTION

1. Field of Invention

Insured Tenant Leasing pertains to the property and casualty personal line insurance industry and facilitates the transformation of data, representing discrete dollar amounts, by a machine through a series of mathematical calculations into a final premium amount paid to an insurer for an insurance policy contract that provides coverage for the tenants' exposure to property losses during the eviction process in the apartment housing, single family residential and multi-family dwelling leasing industries. This method of personal line property insurance facilitate calculation of the premium needed to provide coverage for tenants' exposure to property losses during an eviction whether the tenant is absence or present at the time of the eviction. A combination of a unit loss value calculation and premium calculations are utilized to calculate a tenant paid final premium amount needed to contract with an insurer an insurance policy providing coverage for property loss exposure in the event of a tenant's breach in the leasing agreement between the tenant and landlord resulting in an order for execution of a writ of possession against the tenant and eviction. This coverage applies to the apartment housing, single family residential or multi-family dwelling leasing industries and allows tenants to share the risk of losses and related expenses during an eviction through the payment of the calculated final premium amount to protect the tenants from property (possessions) losses by covering expenses to relocate and store the tenant's property utilizing a pre-selected moving and storage service when an eviction occurs.

The tenant paid premium for the insurance contract comprise the final premium amount that is transformed from data representing discrete dollar amounts which primarily comprise pre-selected moving charges expenses, pre-selected storage charges expenses, courthouse records statistical data pertaining to evictions for a specific geographical area, data pertaining to rented units in the same specific geographical area, and profit margin data, by means of a software application spreadsheet or other data processing apparatus comprising software used to manipulate numerical data through a series of mathematical calculations, into the final premium amount utilized by the Insured Tenant Leasing method for writing an insurance policy to enable coverage in an insurance contract for tenant's exposure to property (possessions) losses during the eviction process. The premium is paid to the insurer to enable coverage for the tenant's exposure to loss of possessions (property) that are in the tenant's rented apartment, single family resident or multi-family dwelling during the eviction process as the result of a breach in the lease agreement between the tenant and landlord. The breach may be due to the diminishing of, or decrease in the tenant's level of income to a level below the level required to qualify for the rental unit during the rental application process. Coverage is triggered when the diminishing of, or decrease in the tenant's level of income is caused by some fortuitous events comprising involuntary termination of employment, injury, medical emergency, hospitalization, death of a domestic partner, death of a spouse, hardship, and other uncontrollable or unavoidable circumstances that is eligible for coverage and acceptable by the insurer, that results in a breach in the lease agreement between the landlord and tenant and subsequently followed by a tenant holding over filing and/or a tenant fail to pay rent that is due filing and the ordering and execution of a writ of possession against the tenant and eviction.

A. Classification definitions of the Claimed Invention:

Insured Tenant Leasing is a method for writing an insurance policy categorized in

US PATENT SUBCLASS 705/4˜Insurance (e.g., computer implemented system or method for writing insurance policy, processing insurance claim, etc.)

B. Specific Documents Related to the Invention:

1.) USPTO Disclosure Document No. 557867—Dated—Jul. 28, 2004;
2.) Provisional Application for Patent Cover Sheet—Express Mail Label ED569747900US—Dated—Nov. 18, 2004
3.) State Street V. Signature, 1996 “. . . in Arrythmia . . . , we held that the transformation of electrocardiograph signals from a patient's heartbeat by a machine through a series of mathematical calculations constituted a practical application of an abstract idea . . . Today, we hold that the transformation of data, representing discrete dollar amounts, by a machine through a series of mathematical calculations into a final share price, constitutes a practical application of a mathematical algorithm, formula, of calculation, because it produces ‘a useful, concrete and tangible result’—a final share price . . . ”
4.) U.S. Provisional Application No. 60/630,088
Filing Date Nov. 22, 2004
Name of Applicant: James L. Coleman Jr., College Park, Ga.
Title of Invention: Insured Tenant Leasing

2. Related Art

A. Problems in Related Art

Reference to the following Georgia House Bill 762 Entitled an Act in the State of Georgia in June 2004 illustrate the problems that are currently unaddressed by the state of technology and prior art as they relate to protection of tenant's property when a writ of possession is executed and eviction. “. . . the placement of such personal property on some portion of the landlord's property or on other property as may be designated by the landlord and as may be approved by the executing officer; provided, however, that the landlord shall not be a bailee of such personal property and shall owe no duty to the tenant regarding such personal property. After execution of the writ, such property shall be regarded as abandoned . . . ” H.B. 762

HOUSE BILL 762:

04 HB 762/AP

HOUSE BILL 762 (AS PASSED HOUSE AND SENATE)

By: Representatives Floyd of the 69^{th}, Post 2, Marin of the 66^{th}, Thomas Morgan of the 33^{rd}, Post 2, and Thompson of the 69^{th}, Post 1

### A BILL TO BE ENTITLED AN ACT

To amend Chapter 7 of Title 44 of the Official Code of Georgia Annotated, relating to landlord and tenant, so as to change certain provisions relating to judgment, writ of possession, landlord's liability for wrongful conduct, and distribution of funds paid into court; to provide for removal of a tenant or the tenant's personal property under certain circumstances; to repeal conflicting laws; and for other purposes.

### BE IT ENACTED BY THE GENERAL ASSEMBLY OF GEORGIA:

### SECTION 1.

Chapter 7 of Title 44 of the Official Code of Georgia Annotated, relating to landlord and tenant, is amended in Code Section 44-7-55, relating to judgment, writ of possession, landlord's liability for wrongful conduct, and distribution of funds paid into court, by inserting at the end thereof a new subsection (c) to read as follows: “(c) Any writ of possession issued pursuant to this article shall authorize the removal of the tenant or his or her personal property or both from the premises and permit the placement of such personal property on some portion of the landlord's property or on other property as may be designated by the landlord and as may be approved by the executing officer; provided, however, that the landlord shall not be a bailee of such personal property and shall owe no duty to the tenant regarding such personal property. After execution of the writ, such property shall be regarded as abandoned.”

### SECTION 2.

All laws and parts of laws in conflict with this Act are repealed.

The property and casualty personal line insurance industry currently does not offer tenants coverage for exposure to property (possessions) losses through paid premiums during an eviction. Writ of possessions are ordered for execution and executed against the tenants in their presence or absence and thereby the tenants are exposed to property (possession) losses and particularly when the tenant is absent during the execution of the order and an eviction. The tenant currently has no recourse during his absence and the execution of the order, regardless of the circumstances or fortuitous events triggering the decrease in the tenant's income level resulting in the breach of the rental agreement and subsequently a writ of possession and eviction. Laws in other states and provinces similar to Georgia's House Bill 762 passed by the Georgia House and Senate in June 2004 give landlords rights within the Landlord and Tenant Law of states pertaining to writ of possessions and evictions but does not prescribe an option for tenant selected protection for the tenants' property during some fortuitous event and breach in the rental agreement between the tenant and landlord resulting in an eviction. Nor do the statutes consider why the breach in the agreement occurred. Insured Tenant Leasing considers protection for the tenant's property through pre-arranged coverage contracted in an insurance policy by payment of a final premium amount transformed from data representing discrete dollar amounts which primarily comprise pre-selected moving and pre-selected storage expenses, court house records statistical data pertaining to evictions for a specific geographical area, data pertaining to rented units in the same specific geographical area, and profit margin data by a machine through a series of mathematical calculations into a final premium amount to cover the exposure to loss of the tenant's possessions that are declared abandoned, and possessions that are being dispossessed by the landlord granted the writ of possession and eviction.

Economic conditions resulting in vacillating unemployment rates and other adversity in the economy create unexpected losses in tenant's income levels. Likewise, decreases in the tenant's income level can be caused by unexpected legitimate fortuitous events such as injuries, medical emergencies, hospitalization, death of a spouse, death of a domestic partner or hardships that can occur at unexpected times. These specific adverse fortuitous events can affect the tenants' abilities to maintain their contractual lease agreements and obligation with the landlord as they did prior to the occurrence of the decrease or diminishing of the tenant's income due to these fortuitous events. Related art does not consider the transformation of data, representing discrete dollar amounts, by a machine through a series of mathematical calculations into a final premium amount to provide coverage for the exposure to property losses that tenants are exposed to during evictions due to those fortuitous events mentioned herein or other similar fortuitous events.

Insured Tenant Leasing facilitate calculation of a final premium amount needed in order to pay the cost of coverage to protect tenant's property exposure to loss during an eviction by means of a common pool of tenants sharing the risk through payment of premiums to cover the cost of pre-selected moving and storage expenses to protect the tenant's property from loss in the event of an unavoidable fortuitous events resulting in a breach in the rental agreement and a writ of possession and eviction. Related art does not provide for this sharing of risk through payment of premiums. Insured Tenant Leasing provide for this sharing of risk through payment of premiums by a common pool of tenants sharing the cost of coverage in the form of tenant paid premiums transformed from data representing discrete dollar amounts which primarily comprise pre-selected moving and pre-selected storage expenses, court house records statistical data pertaining to evictions for a specific geographical area, data pertaining to rented units in the same specific geographical area, and other profit margin data by a machine through a series of mathematical calculations into a final premium amount.

Related art that protect landlords' interests are not geared toward a common pool of tenants sharing the risk of tenants' property (possessions) loss during an eviction through payment of a premium amount to cover the tenants' exposure to property losses as does Insured Tenant Leasing, but more so toward providing coverages for landlords.

B. Description of the Related Art

Tenant Security Deposit

Money furnished by a tenant to a landlord to secure the performance of the terms and condition of a rental agreement, as a security for damages to the leased premises. Most landlords require the tenant to put down an amount of money, separate from rent, to protect the landlord from losses due to tenant-caused damages, appropriate cleaning not performed by the tenant, and unpaid rent and utilities owed by the tenant after the rental agreement is terminated. This is usually called the “cleaning” or “security” deposit. Any money (or its equivalent) collected by the landlord to ensure the premises are left clean, no damages have occurred, and that all rent and utilities are paid is considered to be a security deposit. The tenant's unavoidable circumstances are not considered with the security deposit and the tenants are not given protection or coverage for their exposure to property losses in uncontrollable or unavoidable fortuitous events when the breach of the rental agreement results in a writ of possession and eviction. There is no insurance contract or calculation of a tenant paid premium.

Rent Loss Insurance

Insurance that protects a landlord against loss of rent or rental value due to fire or other casualty that renders the leased premises unavailable for use and as a result of which the tenant is excused from paying rent. Coverage is negotiated between the landlord and insurer for the landlord to pay premiums for coverage. Whenever rental income is to be used in qualifying for a mortgage loan, the borrower must have rent loss insurance coverage on the investment property providing the insurer's liability in an amount equal to the gross monthly rent for at least six months. The tenant's unavoidable circumstances are not considered with rent loss insurance and the tenants are not given protection or coverage for their exposure to property losses in uncontrollable or unavoidable fortuitous events when the breach of the rental agreement results in a writ of possession and eviction. There are no calculations for tenant premiums and the landlord is responsible for payment of premiums to the insurer.

Rent Insurance

Rent Insurance is a form of business interruption insurance for the landlord. It protects building owners against loss of income when the building cannot be rented because of damage from any of its insured perils or when a building has been leased and a projected rent loss is expected when a building is leasable but is not yet fully leased. It provides income while an insured's building is untenantable. The tenant's unavoidable circumstances are not considered with rent insurance and the tenants are not given protection or coverage for their exposure to property losses in uncontrollable or unavoidable fortuitous events when the breach of the rental agreement results in a writ of possession and eviction.

There are no calculations for tenant premiums.

Renters Insurance

Renters insurance pays the tenant if the tenant's personal property is damaged or stolen from a rental unit that the tenant has a right to under a binding lease agreement. Renters insurance covers fire and smoke damage, theft, vandalism, damage from windstorms and hail, damage from explosions, water damage from plumbing problems, and many other hazards. It also protects the tenant from liability if an accident happens in the rented unit and may pay the tenant temporary living expenses if an emergency forces the tenant to leave the dwelling unit. The landlord may require that a tenant pay for the cost of premiums for property coverage for the tenant's personal property in the dwelling unit. Renters insurance is a term for the non-owner occupant of a dwelling or apartment. Renters Insurance does not give the tenant protection or coverage for their exposure to property losses in uncontrollable or unavoidable fortuitous events associated with an eviction and there are no premiums calculated to share this risk.

Tenant Insurance

The landlord is not normally able to insure a tenant's personal property through their rental property insurance policy. There are a number of reasons why, including the fact that neither the landlord, nor the insurer, has any knowledge or control of the extent or value of the contents that may be brought into the property. Tenant must have “Renters Insurance”. (See related art entitled Renter's Insurance above). Tenant Insurance does not give the tenant protection or coverage for their exposure to property losses associated with an eviction and there are no premiums calculated to share this risk.

Damage Insurance

The landlord may require that a tenant pay for the cost of premiums for commercial insurance coverage obtained by the landlord to secure the performance by the tenant of the terms and conditions of the rental agreement, generally known as damage insurance. This insurance provides protection against liability for damage to the landlord's property, as distinguished from liability for bodily injury. In the majority of cases, property damage insurance is written in connection with the bodily injury protection, the premiums and limits of insurance being distinct. Damage Insurance does not give the tenant protection or coverage for their exposure to property losses associated with an eviction and there are no premiums calculated to share this risk.

Landlord 's Insurance

Landlord's Insurance helps to protect the landlord's investment by providing cover for buildings, contents, limited contents for part-furnished properties and legal expenses and unpaid rent should the tenant default on the tenancy agreement. Coverage is negotiated between the landlord and insurer for the landlord to pay premiums for coverage. There are no calculations for tenant premiums and the landlord is responsible for payment of premiums to the insurer. Landlord's Insurance does not give the tenant protection or coverage for their exposure to property losses associated with an eviction and there are no premiums calculated to share this risk

Commercial Insurance

Purchased by landlord to provide property and casualty insurance coverage for a tenant, generally known as renter's insurance. Commercial Insurance is typically issued to corporations or organizations, or to the individual who owns a business operation, and includes coverage like Commercial Property, Commercial Auto, and Commercial General Liability. When applicable to Commercial Property there are no calculations for tenant premiums and the landlord is responsible for payment of premiums to the insurer. Commercial Insurance does not give the tenant protection or coverage for their exposure to property losses associated with an eviction and there are no premiums calculated to share this risk

Builder 's Risk Insurance—Rent Loss Insurance

Builder's risk insurance covers improvements pursuant to standard industry custom and practice. Since the lease always address indemnity issues, the work letter incorporates them by reference. The representatives of both the landlord and the builder ensures that the language of the work letter includes liability insurance coverage, either by specific provision for it or by incorporating by reference the insurance provisions in the lease. Builder's risk Insurance does not give the tenant protection or coverage for their exposure to property losses associated with an eviction and there are no premiums calculated to share this risk

Rent Bonds—Surety, Financial, Performance Bonds

A Rent bond is a three-party agreement between a surety company, a landlord and a tenant. The third party (Surety Company) guarantees to the second party (landlord) the successful performance of the first party (tenant). The surety company guarantees that the obligations of the tenant to the landlord will be performed in accordance with a contract, statute or regulations. Bonds are used to protect public and private funds from financial loss. A bond and an insurance policy are not the same. The costs of assumed losses are calculated into the price of an insurance policy premium. Relative frequency of expectation of losses in a common pool of homogeneous units is not included in the cost of bond premiums, only underwriting expenses are factored into the rates. Just as a bank evaluates loan applications, surety company underwriters evaluate risks in a similar way by considering business and personal financial statements, credit reports, credit references and other factors. A surety company's fiscal results are severely impacted when losses on bonds do occur. There are no calculations for tenant premiums based on a common pool of tenants sharing risks and the bond functions similar to a security deposit and must be collateralized. Rent, surety, financial, and performance bonds, do not give the tenant protection or coverage for their exposure to property losses associated with an eviction and there are no premiums calculated to share this risk.

Security Bond

A security bond in lieu of a security deposit provides a financial guarantee for the property owner that the property will be returned to its move-in condition after a tenant moves out before the term of the lease has expired or the tenant skips out on the lease. The bond must be paid when the tenant's first month's rent is paid. The non-refundable bond cost is calculated as a percentage of the ongoing security deposit. The security bond and an insurance policy are not the same. The relative frequency of expectation of losses in a common pool of homogeneous units is not included in the cost of the security bond premiums, only underwriting expenses are factored into the rates. Just as a bank evaluates loan applications, surety company underwriters evaluate risks in a similar way by considering business and personal financial statements, credit reports, credit references and other factors. There are no calculations for tenant premiums based on a common pool of tenants sharing risks and the security bond functions similar to a security deposit. Security bonds, do not give the tenant protection or coverage for their exposure to property losses associated with an eviction and there are no premiums calculated to share this risk.

Security Deposit Insurance

Deposit insurance is a revolutionary new concept that allows tenants to pay a small monthly insurance fee instead of coming up with a large cash security deposit in addition to the first (and sometimes last) month's rent when signing a new lease. To participate in the program, the property manager completes a master application which lists the number of properties, typical rent and security deposit requirements. The property owner buys the insurance policy to protect against damage and other losses. The owner then passes that cost onto tenants for a monthly fee. The insurer issues a policy, and provides a starter kit that contains all the necessary forms and renter marketing materials. In the event of a tenant default in rent or a claim for damages, the insurance company pays the landlord. This coverage is geared more toward the covering the financial obligations to the landlord.

If a tenant defaults on the fee payment and the rent payment, a tenant holding over filing/ or tenant fail to pay rent that is due is subsequently applied for by the landlord and a writ of possession and eviction still may occur, exposing the tenant to property (possession) losses in an eviction that is not covered by the security deposit insurance. On the other hand Insured Tenant Leasing provides a unique and economical means for protecting tenant's exposure to property losses during an eviction by facilitating the payment of a premium transformed from data representing discrete dollar amounts which primarily comprise pre-selected moving and storage services expenses and court house statistical data pertaining to evictions for a specific geographical area and data pertaining to rented units in the same specific geographical area, by a machine through a series of mathematical calculations into a final premium amount paid to cover the tenant's risk of exposure to property losses during an eviction.

SureDeposit Bond

SureDeposit replaces security deposits with a surety bond. The SureDeposit bond does not provide coverage for tenant's property (possessions) exposed to loss during an eviction. The bond provides the tenants with the short-term benefit of being able to move into an apartment for less cash than a security deposit would require. The tenant completes a Bond Acknowledgment Form when the tenant's new lease is approved and pay the one-time nonrefundable premium. SureDeposit coverage will begin immediately. Depending on the tenant's personal financial situation, and spending habits, SureDeposit may also save the tenant in the long-term. The major benefit of SureDeposit is geared toward the landlord. Renters can use the bond to cover their security deposit at another property owned by the same company only if they meet all the obligations under their lease, including paying for any damages. Even with the bond, tenants are responsible for paying for any damages they've done to their apartment. SureDeposit only pays for damages if the renter does not, and will then go after the renter to collect the money back. If the security deposit at their new apartment is higher the tenant will need to buy additional bond coverage. When the tenant is unable to fulfill the lease agreement in any case due to a fortuitous event then SureDeposit Bond does not provide protection for the tenant nor for the tenant's property. If the tenant is not able to fulfill the commitments under the lease, the tenant will be required to reimburse the surety company for damages, loss of rent and related expenses and the tenant may still end up with the landlord applying for a tenant holding over filing/ or tenant fail to pay rent filing, a writ of execution and subsequently an eviction. On the other hand Insured Tenant Leasing provides a unique and economical means for protecting tenant's exposure to property losses during an eviction by facilitating the payment of a premium transformed from data representing discrete dollar amounts which primarily comprise pre-selected moving and storage services expenses and court house statistical data pertaining to evictions for a specific geographical area and data pertaining to rented units in the same specific geographical area, by a machine through a series of mathematical calculations into a final premium amount paid to cover the tenant's risk of exposure to property losses during an eviction.

Imposition Deposits

Deposits held by the Lender to pay when due (1) any water and sewer charges which, if not paid, may result in a lien on all or any part of the Collateral Property, (2) the premiums for fire and other hazard insurance, rent loss insurance and such other insurance as Lender may require, (3) taxes, assessments, vault rentals and other charges, if any, general, special or otherwise, including all assessments for schools, public betterments and general or local improvements, which are levied, assessed or imposed by any public authority or quasi-public authority, and which, if not paid, will become a lien, on the Land or the Improvements, and (4) amounts for other charges and expenses which Lender at any time reasonably deems necessary to protect the Collateral Property, to prevent the imposition of liens on the Collateral Property, or otherwise to protect Lender's interests, all as reasonably estimated from time to time by Lender (the “Imposition Deposits”). The tenant's unavoidable circumstances are not considered in this type of insurance nor are tenants given protection coverage for their possessions in the event of an eviction.

### F. BRIEF SUMMARY OF THE INVENTION

The general idea of Insured Tenant Leasing is a method for writing an insurance policy where the combination of a unit loss value calculation and a final premium amount calculation in a mathematical algorithm are utilized to calculate a tenant paid final premium amount needed to contract with an insurer an insurance policy providing coverage for property loss exposure when an eviction occurs and the exposure to the related expense in the form of expenses paid for pre-selected moving and pre-selected storage service as stipulated in the insurance policy to protect the tenant's property from loss by relocating and storing the tenant's property to safety during an eviction process. The method makes use of a tangible, concrete and useful final premium amount transformed from data representing discrete dollar amounts which primarily comprise pre-selected moving and pre-selected storage expenses and court house statistical data pertaining to evictions for a specific geographical area and data pertaining to rented units in the same specific geographical area, by a machine through a series of mathematical calculations, comprising a unit loss value algorithm and a premium calculation algorithm, that is paid by the tenant to the insurer.

The Insured Tenant Leasing method for writing an insurance policy is advantageous to tenants and offer tenants assistance with currently unavailable options when recuperating from the adverse circumstances inherent in the eviction process. Tenants can selected and decide where their property will be delivered in the case of an eviction and how long stored at a pre-selected storage location. The tenant can experience a degree of security and comfort in knowing that losses will not occur in the disposition of there property whether they or present or absent if a fortuitous event takes place causing an eviction. Alternative means for disposition of property during an eviction by pre-selecting the moving service and storage location and informing the landlord of the coverage during the application process are available with the Insured Tenant Leasing Method for writing an insurance policy.

The Insured Tenant Leasing Method of insurance solves the problem of tenants losing their property that may be setout during an eviction. It eliminates the removal of tenants' possession to roadsides and to locations other than the location desired by the insured tenant if the tenant's property (possessions) is declared abandoned when a writ of execution is granted to the landlord according to landlord and tenant laws.

The object of the invention is to give tenants an alternative method of handling the potential for loss of property during an eviction. Insured Tenant Leasing is design to give tenants options and protection that currently are not available. When unfortunate circumstances result in an eviction, the object of Insured Tenant Leasing becomes to protect the tenant's property and to provide a means of assistance in the tenant's recuperation from the circumstances.

### G. DETAILED DESCRIPTION OF THE VIEWS OF DRAWINGS

FIG. 1.—Depicts the Insured Tenant Leasing System Flowchart for the Unit Loss Value (Algorithm) and Premium Calculator (Algorithm) showing the system flow comprising the pre-selected moving and storage expenses representing discrete dollar amounts feeding into the Unit Loss Value algorithm giving a resulting UNITLOSS VALUE final amount and the continuation of the system flow comprising the discrete amounts representing the number of evictions in a specific geographical area from Courthouse Records Statistical Data, the discrete amounts representing the number of rented units in a specific area from Rented Units Statistical Data, and Profit Margin Data feeding into the Final Premium algorithm giving the FINAL PREMIUM amount necessary for business operations and cost for insurance claims coverage.

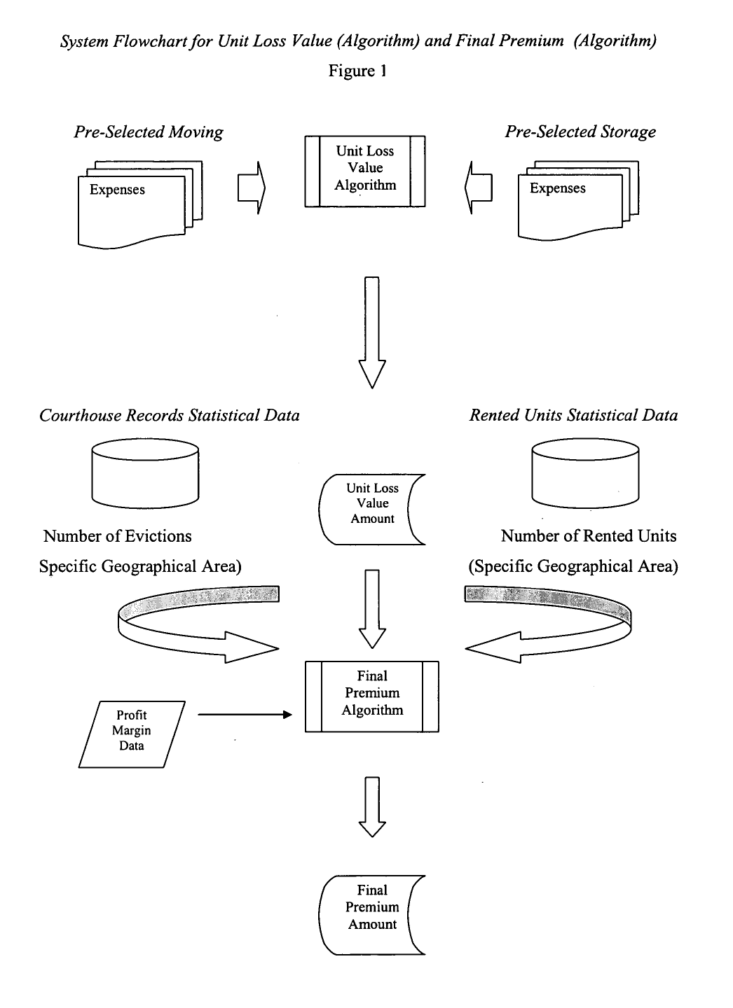

### H. DETAILED DESCRIPTION OF THE INVENTION

1. Description of the Preferred Embodiment

The Insured Tenant Leasing method for writing an insurance policy is simply designed to give the tenant an alternative means for protecting their property from loss during the process of an eviction in the presence or absence of the tenant. This is accomplished by calculating the final premium amount that is herein disclosed as the preferred embodiment and invention. The final premium amount is arrived at through a series of mathematical calculations. The tenant pays the final premium amount to an insurer for an insurance contract to cover the tenant's exposure to property (possessions) loss during an eviction process.

Input data comprising discrete amounts from three categories of data described in this disclosure is entered into a software application spreadsheet or other data processing apparatus comprising software and mathematical algorithms used to manipulate numerical data through a series of mathematical calculations. The data is transformed by means of the mathematical calculations into a final premium amount utilized by the Insured Tenant Leasing method for writing an insurance policy to enable coverage for the tenant's exposure to property (possessions) loss during an eviction.

The input data transformed by means of the mathematical calculations into a final premium amount for the Insured Tenant Leasing method for writing an insurance policy comprises discrete amounts from three categories of data. This data is entered into a computer software application spreadsheet or other data processing apparatus comprising software used to manipulate numerical data through a series of mathematical calculations. The first (1^{st}) category of data is the unit loss value amount comprising pre-selected moving and pre-selected storage expenses. The second (2^{nd}) category is database information comprising the number of rented units in a specific area and the number of evictions in the same area. The third (3^{rd}) category is other data and comprises profit margin factoring information and profit margin data that may be required by an insurer to meet underwriting and actuarial requirements, the costs of doing business and operating expenses.

The transformation of data and resulting final premium amount is arrived at by first determining the unit loss value amount that is to be insured. In this preferred embodiment and invention the unit loss value amount is the sum of charges agreed to by the insurer and the insured tenant in an insurance contract for the tenant's pre-selected moving and storage service expenses in the event of an eviction. The tenant's incurrence of these expenses to protect the tenant's property (possessions) from loss is covered. The tenant's exposure to these expenses to protect the tenant's property are covered by the payment of the final premium to protect the insured's property (possessions) from loss during the eviction process and used as a controlled amount in calculating the premium for the coverage.

The transformation of data and resulting final premium amount is arrived at by first determining the unit loss value amount that is to be insured.

*Calculated: [PRE-SELECTED MOVING SERVICE EXPENSE +PRE-SELECTED STORAGE SERVICE EXPENSE]

The number of rented units (homogenous units) in a specific geographical area is retrieved, once the unit loss value is determined, from dwelling rented unit statistical data comprising census statistics or other rented units informational data.

*Retrieved: [FROM DWELLING RENTED UNITS STATISTICAL DATA]

Similarly the number of evictions per month in the same geographical as the number of rented units is retrieved from courthouse records statistical data comprising courthouse statistics pertaining to dispossessory and evictions.

*Retrieved: [FROM COURTHOUSE RECORDS STATISTICAL DATA]

The relative frequency of evictions per month in the specific geographical of consideration is needed for the final premium calculation. The relative frequency comprises dividing the number of evictions in the specified geographical area under consideration by the number of rented units in the same specified geographical area. The resulting quotient is an aggregate loss frequency due to evictions expected for the specified geographical area under consideration.

*Calculated: [TOTAL NUMBER OF EVICTIONS/TOTAL NUMBER OF RENTED UNITS]

The total value exposed to loss in the specified geographical area is also needed in order to calculate the final premium amount. The total value exposed to loss comprises multiplying the number of rented units in the specified geographical area under consideration by the unit loss value amount. The resulting product is total value exposed to loss.

*Calculated: [TOTAL NUMBER OF RENTED UNITS*UNIT LOSS VALUE]

The expectation of losses for the specified geographical area of consideration in the preferred embodiment is needed in the series of mathematical calculations that transform the data in into a final premium amount. The expectation of losses comprises multiplying the relative frequency of evictions by the total value exposed. The resulting product is the expectation of losses for the specified geographical area.

*Calculated: [RELATIVE FREQUENCY OF EVICTIONS*TOTAL VALUE EXPOSED]

The profit margin amount in the calculation comprises a percentage over cost of insurance to cover claims, operating expenses, business costs, profits and to fulfill other actuarial requirements.

*Calculated: [PROFIT MARGIN PERCENTAGE*EXPECTATION OF LOSSES]

The final premium amount per month comprises the resulting amount received by dividing the expectation of losses plus profit margin amount for the specific geographical area by the total number of rented units in the same specified geographical area.

*Calculated: [(EXPECTATION OF LOSSES+PROFIT MARGIN AMOUNT)/TOTAL NUMBER OF RENTED UNITS]

The final premium amount or fee amount per annum is equal to the final premium amount per month multiplied by 12.

*Calculated: [FINAL PREMIUM AMOUNT*12]

This tangible, concrete and useful final premium amount transformed from data representing discrete dollar amounts which is primarily comprised of pre-selected moving and pre-selected storage expenses and court house statistical data pertaining to evictions for a specific geographical area and data pertaining to rented units in the same specific geographical area, by a machine through a series of mathematical calculations, comprising a unit loss value algorithm and a premium calculator algorithm, is paid by the tenant to the insurer through a method for writing an insurance policy as follows:

The tenant contracts with the insurer authorized to market the product and that has met all statutory forms, program submissions and filing requirements by the state jurisdiction for the specified geographical area under consideration. The product is offered through an authorized landlord or an authorized insurance agency in compliance with the regulatory division of the State Department of Insurance or the state's Insurance Commissioner's Office.

The point of sale marketing strategy to integrate this embodiment, comprised in an insurance contract or policy of a property and casualty (liability) personal line insurance product, into the market place is determine by the authorized marketing entity. The first and highly recommended preferred method is for the product to be integrated into the market place by an offering of the coverage coming from the limited licensee landlord authorized by the state insurance commissioner or the authorized landlord's management staff to the tenant during time of the rental application process. A second method and less preferred method of integration is for the authorized or unauthorized landlord to refer the tenant desiring the coverage to a third party such as a licensed insurance agency authorized to offer the product to the general public. The embodiment will be made available through the policy, forms, and contracts of the personal line insurance product submitted to the insurance commissioners as filings and approved by the insurance commissioner prior to marketing the product in the governing insurance commissioner's jurisdiction.

The landlord if not the offering limited licensee is provided with the specifics of the insurance contract and the information pertaining to the pre-selected moving and pre-selected storage services chosen by the tenant after the tenant contracts with the insurance company for coverage. When a breach in the lease agreement occurs and the landlord must apply for a tenant holding over filing or a tenant failure to pay rent that is due filing and subsequently a writ of possession is granted and an order for execution and eviction follows the landlord must contact the insured tenant's pre-selected moving and storage service instead of calling an eviction service. The landlord must call the moving and storage service provided using the pre-selected moving and storage service information provided from the tenant's insurance contract with the insurer.

The invention comprises the following series of mathematical calculations:
Unit Loss Value Amount=[Pre-Selected Moving Service Expense+Pre-Selected Storage Service Expense]
Number of Rented Units=[From Dwelling Rented Units Statistical Data]
Number of Evictions Monthly=[From Courthouse Records Statistical Data]
Relative Frequency of Evictions=[Total Number Of Evictions/Total Number Of Rented Units]
Total Value Exposed =[Total Number Of Rented Units*Unit Loss Value]
Expectation of Losses =[Relative Frequency Of Evictions*Total Value Exposed]
Profit Margin Amount =[Profit Margin Percentage*Expectation Of Losses]
Final Premium Amount Monthly =[(Expectation Of Losses+Profit Margin Amount)/Total Number Of Rented Units]
Final Premium Amount or Fee annually=[Final Premium Amount Monthly*12]

What is claimed is:

1. A method for writing an insurance policy entitled Insured Tenant Leasing and algorithm for providing a final premium amount to pay for the coverage contracted in the policy comprising: a) means for calculating a unit loss value amount, wherein the unit loss value amount comprises discrete dollar amounts for pre-selected moving and pre-selected storage service expenses comprised in an algorithm; b) a means for calculating a final premium amount comprising the data retrieved from census records and other sources comprising the number of rented units in a specified geographical area; c) a means for calculating a final premium amount comprising the data retrieved from courthouse records and other sources comprising the number of evictions in a specified geographical area; d.) a means for calculating a final premium amount comprising profit margin data comprising a percentage over cost of insurance to cover claims, operating expenses, business costs, profits and to fulfill other actuarial requirements and; e) the transformation of the data comprised in a, b, c and d above, by means when entered into a software application spreadsheet or other data processing apparatus comprising software used to manipulate numerical data through a series of mathematical calculations, into the final premium amount utilized by the Insured Tenant Leasing method for writing an insurance policy to enable coverage in an insurance contract for tenant's exposure to property (possessions) losses during the eviction process.

2. The method for writing an insurance policy as recited in claim 1 entitled Insured Tenant Leasing, wherein the means for transforming data into a final premium amount comprises entering data into a software application spreadsheet or other data processing apparatus comprising software used to manipulate numerical data through a series of mathematical calculations in an algorithm or manipulation of the data manually into the final premium amount utilized by the Insured Tenant Leasing method for writing an insurance policy to enable coverage in an insurance contract for tenant's exposure to property (possessions) losses during the eviction process.

3. The unit loss value amount of the method recited in claim 1 wherein the unit loss value amount is comprised of discrete dollar amounts for moving services and storage services charges and is used to in the algorithm to calculate a final premium amount that enables coverage in an insurance contract for tenant's exposure to property (possession losses during the eviction process.

4. The final premium amount of the method recited in claim 1 wherein the final premium amount comprises manipulated numerical data and is arrived at by a series of mathematical calculations in an algorithm comprising the unit loss value amount recited in claim 3 and is used to enable coverage in an insurance contract for tenant's exposure to property (possession losses during the eviction process.

5. The method of claim 1 wherein the method for writing an insurance policy providing coverage for tenant's exposure to property losses during the eviction process comprises the unit loss value amount recited in claim 3.

6. The method of claim 1 wherein the method for writing an insurance policy providing coverage for tenant's exposure to property losses during the eviction process comprises the final premium amount cited in claim 4.

7. The method of claim 1 wherein the final premium amount used to enable coverage in an insurance contract for tenant's exposure to property (possessions) losses during the eviction process comprises entering the number of rented units for a specific geographical area into the algorithm that calculates the final premium amount.

8. The method of claim 1 wherein the final premium amount used to enable coverage in an insurance contract for tenant's exposure to property (possessions) losses during the eviction process comprises entering the number of evictions for a specific geographical area into the algorithm that calculates the final premium amount.

9. The method of claim 1 wherein a machine through a series of mathematical calculations (algorithm) transforms data comprising, a unit loss value amount, a number of rented units comprising the rented units for a specified geographical area, a number of evictions comprising the number of evictions for a specified geographical area, a profit margin amount comprising a percentage over cost of insurance to cover claims and required for operating expenses, business costs, profits and to fulfill other actuarial requirements by means of entering the data into a software application spreadsheet or other data processing apparatus comprising software used to manipulate numerical data through a series of mathematical calculations, into a final premium amount utilized by an insurance product as a fee or premium to enable coverage by an insurance product for tenant's exposure to property (possessions) losses during the eviction process.

10. The method of claim 1 wherein a machine through a series of mathematical calculations (algorithm) transforms data comprising, a unit loss value amount, a number of rented units comprising the rented units for a specified geographical area, a number of evictions comprising the number of evictions for a specified geographical., a profit margin amount comprising a percentage over cost of insurance to cover claims and required for operating expenses, business costs, profits and to fulfill other actuarial requirements by means of a software application spreadsheet or other data processing apparatus comprising software used to manipulate numerical data through a series of mathematical calculations, into the final premium amount utilized by the Insured Tenant Leasing method for writing an insurance policy to enable coverage in an insurance contract for tenant's exposure to property (possessions) losses during the eviction process.
